(19) United States
(12) Patent Application Publication
(10) Pub. No.: US 2006/0044498 A1
(43) Pub. Date: Mar. 2, 2006

(54) Transflective display apparatus and method of manufacturing the same

(75) Inventors: Sin-Doo Lee, Seoul (KR); Jin-Yool Kim, Seoul (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/210,522

(22) Filed: Aug. 23, 2005

(30) Foreign Application Priority Data
Aug. 25, 2004 (KR) 10-2004-67292

(51) Int. Cl. G02F 1/1335

(52) U.S. Cl. 349/117; 349/114

(57) ABSTRACT

A transflective display apparatus includes a first substrate, a pixel electrode formed on the first substrate and a retardation layer. The pixel electrode has a reflective electrode reflecting an external light through a reflective area and a transparent electrode transmitting an internal light through a transmitting area. The retardation layer is formed on at least one of the reflective electrode and the transparent electrode. Therefore, a cell-gap in the reflective area is substantially the same as in the transmissive area, and thus the reflective area and the transmissive area of the transflective display apparatus are operated in the same driving method in spite of the operational distinctions, thereby simplifying a manufacturing process and improving a product reliability.

### CROSS-REFERENCE TO RELATED APPLICATION

This application relies for priority upon Korean Patent Application No. 2004-67292 filed on Aug. 25, 2004, the content of which is herein incorporated by reference in its entirety.

### BACKGROUND OF THE INVENTION

1. Field of the Invention

The present invention relates to a display apparatus and method of manufacturing the same. More particularly, the present invention relates to a transflective display apparatus and a method of manufacturing the transflective display apparatus.

2. Description of the Related Art

In general, display apparatuses are divided into two categories: the transmissive display apparatus and the reflective display apparatus. The transmissive display apparatus relies on a backlight as the light source, and therefore can be used anywhere regardless of the amount of natural illumination. However, the transmissive display apparatus suffers from the disadvantages of high power consumption and poor display quality. Unlike the transmissive display apparatus, a reflective display apparatus relies on the environment to provide the light. Thus, the reflective display apparatus has the advantage of low power consumption and superior display quality compared to the transmissive display apparatus, at least when there is sufficient illumination in the environment. However, the reflective display apparatus may not be as versatile as the transmissive display apparatus because it is difficult to use indoors or in conditions of poor illumination in the environment.

Since consumers want a display apparatus of high display quality that can also easily be used both indoors and outdoors, intensive research has been conducted for the transflective display apparatus. The transflective display apparatus is a hybrid of the transmissive display apparatus and the reflective display apparatus, and has both a reflective area and a transmissive area in a pixel of a display unit. Hereinafter, the term “pixel” is defined as a unit point for displaying an image, and is composed of three dots, each of which represents a unit color such as red, green or blue. The reflective area displays images by using the external light, and the transmissive area displays images by using an internal light source such as the backlight.

In a transflective display apparatus, the reflective area and the transmissive area are distinguished from each other according to the type of pixel electrode. The reflective area is defined by a reflective electrode and the transmissive area is defined by a transmission window that is formed on the reflective electrode to expose a transparent electrode. A common electrode overlays the reflective and transparent electrodes and is comprised of transparent and conductive material.

Sometimes, the display panel of the transflective display apparatus includes a first display panel, a second display panel, and a liquid crystal layer interposed between the first display panel and the second display panel. The first display panel has a transistor formed on a lower substrate and a pixel electrode having the reflective electrode and the transparent electrode. The second display panel has a color filter layer formed on an upper substrate and the common electrode formed on the color filter layer. The transflective display apparatus further includes the backlight to generate the internal light, and a driving circuit to drive the display panel.

Conventional transflective display apparatuses have different cell-gaps in the reflective area and the transmissive area. The need to make different cell-gaps complicates the manufacturing process of the transflective display apparatus and increases its cost of production. The manufacturing process is further complicated by the fact that the driving circuit of the conventional transflective display apparatus provides each of the reflective and transparent electrodes with a different voltage from each other.

Recently, a multi-mode transflective display apparatus has been researched and developed. The multi-mode transflective display apparatuses each has a different liquid crystal alignment from each other and the same cell-gap in the reflective and transmissive areas. However, as the transflective display apparatuses each operate at a different liquid crystal mode from each other in the reflection and transmissive areas, the transflective display apparatuses each have different optical characteristics and a different response speed from each other in the reflective and transmissive areas.

A transflective display apparatus that does not suffer from the above-described disadvantages is desired.

### BRIEF SUMMARY OF THE INVENTION

The present invention provides a transflective display apparatus of easy manufacturability and improved display quality.

The present invention also provides a method of manufacturing the transflective display apparatus.

In one aspect of the present invention, a transflective display apparatus has a first substrate, a pixel electrode and a retardation layer. The pixel electrode has a reflective electrode reflecting an external light and a transparent electrode transmitting an internal light. The pixel electrode is formed on the first substrate and the retardation layer is formed on at least one of the reflective electrode and the transparent electrode.

In another aspect of the present invention, a transflective display apparatus includes a first panel, a second panel, a variable retardation layer and a lower retardation layer.

The first panel includes a first substrate on which a pixel electrode is formed, and the pixel electrode has a transparent electrode for transmitting an internal light and a reflective electrode for reflecting an external light. The second panel includes a second substrate spaced apart from and facing the first substrate, and a common electrode is formed on the second substrate. The variable retardation layer is formed between the pixel electrode and the common electrode. The lower retardation layer is formed on one of the transparent electrode and the reflective electrode.

The variable retardation layer may include a liquid crystal layer. If the liquid crystal layer includes a twist nematic mode liquid crystal, the lower retardation layer is formed on the reflection electrode. If the liquid crystal layer is in a vertically-aligned mode, the lower retardation layer is formed on the transparent electrode, and the second panel further includes an upper retardation layer.

The phase changing axes of the lower and upper retardation layers may be substantially parallel to each other, and perpendicular to the phase changing axis of the variable retardation layer. The retardation layer converts a linearly polarized light supplied thereto to a circularly polarized light or an elliptically polarized light. Alternatively, when a first axis component of the linearly polarized light has a first wavelength and a second axis component of the linearly polarized light has a second wavelength, the retardation layer may change the phase of the first axis component, so that the first wavelength is in a wavelength range from about 1/10 of the second wavelength to about ½ of the second wavelength.

In another aspect of the invention, there is provided a method of manufacturing a transflective display apparatus. A pixel electrode is formed on a first substrate. The pixel electrode includes a transparent electrode transmitting an internal light and a reflective electrode reflecting an external light. A retardation layer is formed on at least one of the reflective electrode and transparent electrode.

The retardation layer may be formed as follows. A first inductive layer and a second inductive layer are formed on the reflective electrode and the transparent electrode, respectively, changing the surface characteristics of the electrodes. An optical anisotropic layer including an optical anisotropic material is formed on the first and the second inductive layers, and the optical anisotropic layer is cured so as to align the optical anisotropic material in accordance with the surface characteristic of the first or second inductive layer.

According to the present invention, the cell-gap in the reflective area is substantially the same as the cell-gap in the transmissive area. Thus, the reflective area and the transmissive area of the transflective display apparatus may be operated by the same driving method in spite of the operational distinctions, simplifying a manufacturing process and improving product reliability.

### BRIEF DESCRIPTION OF THE DRAWINGS

The above and other advantages of the present invention will become readily apparent by reference to the following detailed description when considered in conjunction with the accompanying drawings, wherein:

FIG. 1 is a view showing a transflective display apparatus according to an exemplary embodiment of the present invention;

FIG. 2A is a view showing a polarized state of a light when a white image is displayed on a screen of the transflective display apparatus of FIG. 1;

FIG. 2B is a view showing a polarized state of a light when a black image is displayed on the screen of the transflective display apparatus of FIG. 1;

FIG. 3 is a view showing a transflective display apparatus according to another exemplary embodiment of the present invention;

FIG. 4A is a view showing a polarized state of a light when a white image is displayed on a screen of the transflective display apparatus of FIG. 3;

FIG. 4B is a view showing a polarized state of a light when a black image is displayed on the screen of the transflective display apparatus of FIG. 3;

FIG. 5 is a view showing a transflective display apparatus according to still another exemplary embodiment of the present invention;

FIGS. 6A to 6D are views showing processing steps for a method of forming the retardation layer and a complementary layer of the transflective display apparatus according to an exemplary embodiment of the present invention;

FIG. 7 is a graph showing a transmittance or a reflectance of a light as a function of an operational voltage of the transflective display apparatus of FIG. 1 in accordance with a twisting angle of a liquid crystal.

FIG. 8 is a graph showing a theoretical and a measured transmittance and a reflectance of the transflective display apparatus as a function of an operational voltage when the twisting angle is about sixty degrees; and

FIG. 9 is a graph showing a response characteristic of the transflective display apparatus of which a twisting angle is about sixty degrees.

### DESCRIPTION OF THE EMBODIMENTS

The invention is described more fully hereinafter with reference to the accompanying drawings in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated ninety degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Embodiments of the invention are described herein with reference to cross-sectional illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include variations in shapes that result, for example, from manufacturing, and the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as what is commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

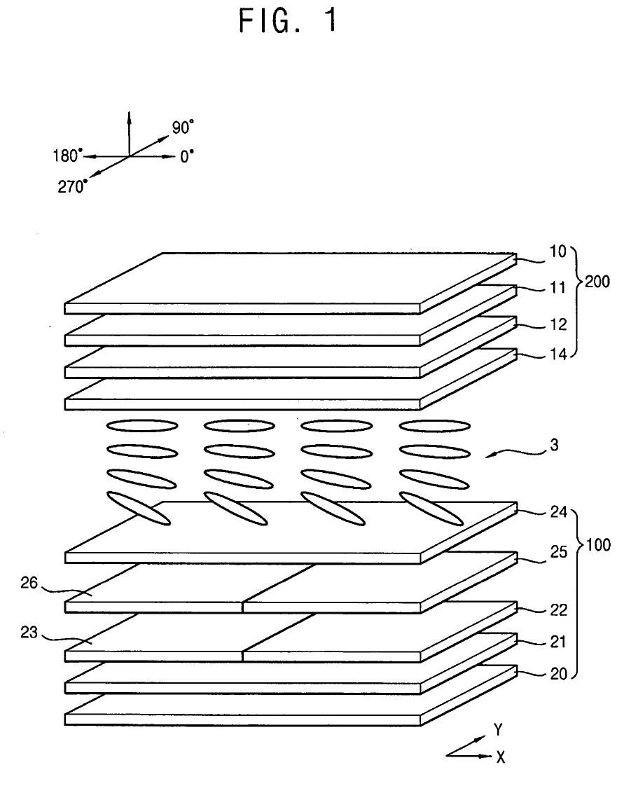

FIG. 1 is a view showing a transflective display apparatus according to an exemplary embodiment of the present invention.

Referring to FIG. 1, a transflective display apparatus includes a first panel 100, a second panel 200, and a liquid crystal layer 3 disposed between the first panel 100 and the second panel 200.

The first panel 100 has a first substrate 21, a pixel electrode, a retardation layer 25 and a lower polarizing plate 20 disposed on a bottom surface of the first substrate 21. The pixel electrode includes a transparent electrode 23 and a reflective electrode 22 that are formed on the first substrate 21. The retardation layer 25 is disposed on the reflective electrode 22, and a complementary layer 26 is disposed on the transparent electrode 23. A first liquid crystal alignment layer 24 is disposed on the complementary layer 26 and the retardation layer 25.

The second panel 200 includes a second substrate 11, an upper polarizing plate 10 disposed on a top surface of the second substrate 11, a transparent common electrode 12 disposed on a bottom surface of the second substrate 11, and a second liquid crystal alignment layer 14.

The retardation layer 25 converts a linearly polarized light supplied thereto into a circularly polarized light or an elliptically polarized light. Alternatively, when a first axis component of the linearly polarized light has a first wavelength and a second axis component of the linearly polarized light has a second wavelength, the retardation layer 25 changes a phase of the first axis component, so that the first wavelength is in a wavelength range from about 1/10 of the second wavelength to about ½ of the second wavelength.

In the present embodiment, the retardation layer 25 changes the phase of the first axis component so that the first wavelength is about a quarter of the second wavelength. The phase changing axis of the retardation layer 25 is at an angle of 45-degree direction with respect to an X-Y plane [We should define “X-Y plane”]. The phase changing axis of the retardation layer 25 converts a velocity of light that is traveling substantially parallel to the phase changing axis into a velocity that is different from the velocity of light that is traveling substantially perpendicular to the phase changing axis. As a result, when a light passes through the retardation layer 25, the phase changing axis of the retardation layer 25 converts the first axis component of the light to about ¼ wavelength of the second axis component of the light by converting the velocity of light oscillating substantially parallel to the phase changing axis into the velocity of light oscillating substantially perpendicular to the phase changing axis.

The complementary layer 26 includes a refractive index isotropic material (Nx=Ny=Nz, Nx is a refractive index in an X direction, Ny is a refractive index in a Y direction and Nz is a refractive index in a Z direction) having the same refractive index with respect to an X-Y plane or a refractive index anisotropic material (Nx=NyNz). When the complementary layer 26 includes the refractive index anisotropic material, a phase changing axis of the complementary layer 26 is substantially parallel to the Z direction.

The complementary layer 26 and the retardation layer 25 include the same insulating material. The complementary layer 26 is formed to the same thickness as the retardation layer 25, and thereby has a height substantially identical to that of the retardation layer 25. The phase changing axis of the complementary layer 26 and the phase changing axis of the retardation layer 25 may extend in different directions from each other.

An inductive layer (not shown) may be further disposed between the reflective electrode 22 and the retardation layer 25 and between the transparent electrode 23 and the complementary layer 26. The inductive layer aligns the phase changing axes of the retardation layer 25 and the complementary layer 26 according to their surface characteristics.

As stated above, the second panel 200 includes a second substrate 11, a common electrode 12, a second liquid crystal alignment layer 14 and an upper polarizing plate 10. The alignment direction of the second liquid crystal alignment layer 14 is at an angle of about sixty degrees with respect to the alignment direction of the first liquid crystal alignment layer 24. In an exemplary embodiment, the alignment direction of the first liquid crystal alignment layer 24 is at an angle of about sixty degrees with respect to the second liquid crystal alignment layer 14, and the alignment direction of the second liquid crystal alignment layer 14 is at an angle of about zero degrees.

The upper polarizing plate 10 is attached to an upper surface of the second substrate 11. The upper polarizing plate 10 has a transmitting axis substantially perpendicular to a transmitting axis of the lower polarizing plate 20.

The liquid crystal layer 3 comprises liquid crystal having a positive permittivity anisotropy such as a twisted nematic liquid crystal. In an exemplary embodiment, the liquid crystal layer 3 has a thickness in a range of about 1.5 μm to about 3.0 μm. The liquid crystal layer 3 rotates a linearly polarized light by an angle of about forty-five degrees to about ninety degrees.

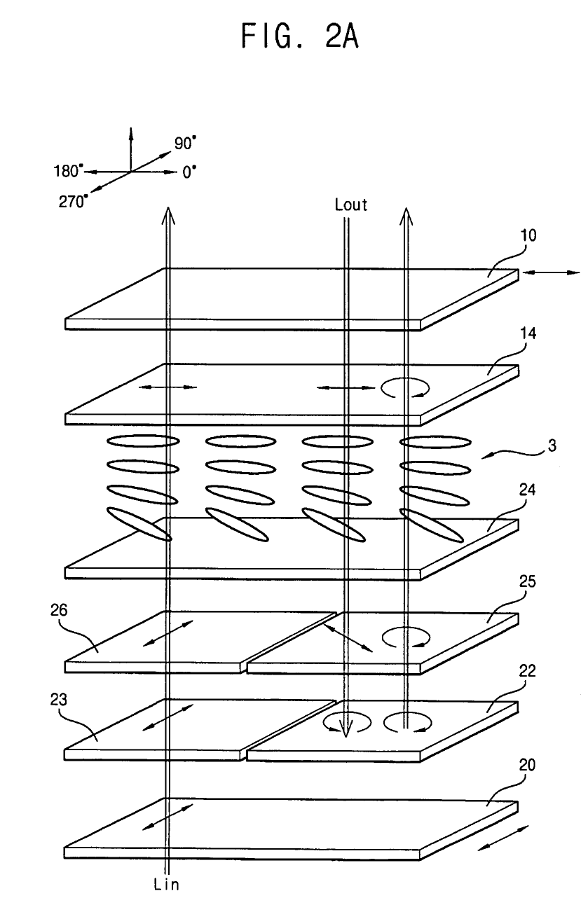

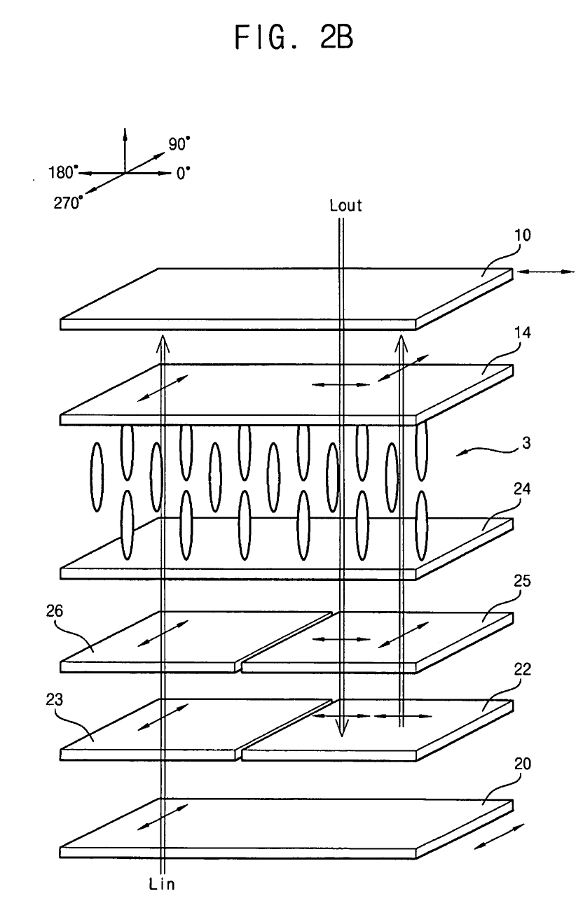

FIG. 2A is a view showing polarized light when a white image is displayed on a screen of the transflective display apparatus of FIG. 1. FIG. 2B is a view showing polarized light when a black image is displayed on the screen of the transflective display apparatus of FIG. 1.

In FIGS. 2A and 2B, the transmitting axis of the lower polarizing plate 20 is parallel to a 90 (or 270)-degree direction with reference to a Cartesian coordinate system in FIG. 1 or 2, and the transmitting axis of the upper polarizing plate 10 is parallel to a 0 (or 180)-degree direction with reference to the Cartesian coordinate system in FIG. 1 or 2. When a voltage is not applied to the liquid crystal layer 3 as shown in FIG. 2A, the liquid crystal layer 3 rotates the linearly polarized light to an angle of about 60 degrees, and when the voltage is applied to the liquid crystal layer 3 as shown in FIG. 2B, the liquid crystal layer 3 does not change a phase of the linearly polarized light.

Referring to FIG. 2A, an internal light Lin generated from a backlight assembly (not shown) under the first substrate 21 sequentially passes through the lower polarizing plate 20, the transparent electrode 23, the complementary layer 26, the first liquid crystal alignment layer 24, the liquid crystal layer 3 and the upper polarizing plate 10. Hereinafter, the optical area through which the internal light Lin transmits is referred to as the “transmissive area,” and the internal light Lin is transmitted from the lower polarizing plate 20 to the upper polarizing plate 10 through the transmissive area. In detail, the internal light Lin is polarized along the 90 (or 270)-degree direction by the lower polarizing plate 20, and is rotated by an amount of about 60 degrees while passing through the liquid crystal layer 3, thereby forming a first linearly polarized light. The first linearly polarized light has a component vibrating along the 0 (or 180)-degree direction after passing through the liquid crystal layer 3, and thus passes through the transmitting axis of the upper polarizing plate 10.

External light Lout from outside of the transflective display apparatus sequentially passes through the upper polarizing plate 10, the second liquid crystal alignment layer 14, the liquid crystal layer 3, the first liquid crystal alignment layer 24 and the retardation layer 25. Then, the external light Lout is reflected from the reflection electrode 22 and sequentially passes through the retardation layer 25, the first liquid crystal alignment layer 24, the liquid crystal layer 3, the second liquid crystal alignment layer 14 and the upper polarizing plate 10. In detail, the external light Lout is polarized along the 0 (or 180)-degree direction by the upper polarizing plate 10, and is rotated by an amount of about 60 degrees while passing through the liquid crystal layer 3, thereby forming a second linearly polarized light. The second linearly polarized light is converted into a first circularly polarized light or a first elliptically polarized light by the retardation layer 25. The first circularly polarized light or the first elliptically polarized light is reflected from the reflective electrode 22, and then is converted into a second circularly polarized light or a second elliptically polarized light having a rotation direction opposite to that of the first circularly polarized light or the first elliptically polarized light. Next, the second circularly polarized light or the second elliptically polarized light is converted into a third elliptically polarized light after passing through the retardation layer 25. The third elliptically polarized light is rotated by an amount of about 60 degrees while passing through the liquid crystal layer 3, and is converted to a fourth elliptically polarized light by the liquid crystal layer 3. The fourth elliptically polarized light has a component vibrating along the 0 (or 180)-degree direction, and thus passes through the transmitting axis of the upper polarizing plate 10.

For example, in the transmissive area, the internal light Lin is linearly polarized along the 90 (or 270)-degree direction by the lower polarizing plate 20, and is also linearly polarized along a 150 (or 330)-degree direction by the liquid crystal layer 3. The linearly polarized light polarized along the 150 (or 330)-degree direction has a component vibration along the 0 (or 180)-degree direction, and thus passes through the transmitting axis of the upper polarizing plate 10. In the reflective area, the external light Lout is linearly polarized along the 0 (or 180)-degree direction by the upper polarizing plate 10, and then is linearly polarized along a 60 (or 240)-degree direction by the liquid crystal layer 3. Thereafter, the linearly polarized light polarized along the 60 (or 240)-degree direction is converted into an elliptically polarized light by passing twice through the retardation layer 25. The elliptically polarized light has a component vibrating along the 0 (or 180)-degree direction, and thus passes through the transmitting axis of the upper polarizing plate 10.

Referring to FIG. 2B, in the transmissive area, light that is linearly polarized along the 90 (or 270)-degree direction by the lower polarizing plate 20 passes through the liquid crystal layer 3 without any further polarization. The linearly polarized light polarized along the 90 (or 270)-degree direction does not pass through the transmitting axis of the upper polarizing plate 10, because the linearly polarized light polarized along the 90 (or 270)-degree direction does not include a component vibrating along the 0 (or 180)-degree direction.

In the reflective area, a light linearly polarized along the 0 (or 180)-degree direction by the upper polarizing plate 10 passes through the liquid crystal layer 3 without any further polarization. The linearly polarized light polarized along the 0 (or 180)-degree direction passes through the retardation layer 25, and is reflected from the reflection electrode 22. Thereafter, the reflected light is polarized along the 90 (or 270)-degree direction during a re-passage through the retardation layer 25, so that the reflected light is converted into a linearly polarized light polarized along the 90 (or 270)-degree direction by the retardation layer 25. Then, the linearly polarized light polarized along the 90 (or 270)-degree direction passes through the liquid crystal layer 3 without any further polarization. The linearly polarized light polarized along the 90 (or 270)-degree direction does not pass through the transmitting axis of the upper polarizing plate 10, because the linearly polarized light polarized along the 90 (or 270)-degree direction does not include a component vibrating along the 0 (or 180)-degree direction.

An intermediate gray scale image may be achieved by controlling a voltage applied to the liquid crystal layer 3. The voltage applied to the liquid crystal layer 3 to achieve the intermediate gray scale image ranges from the voltage for achieving a white image to the voltage for achieving a black image.

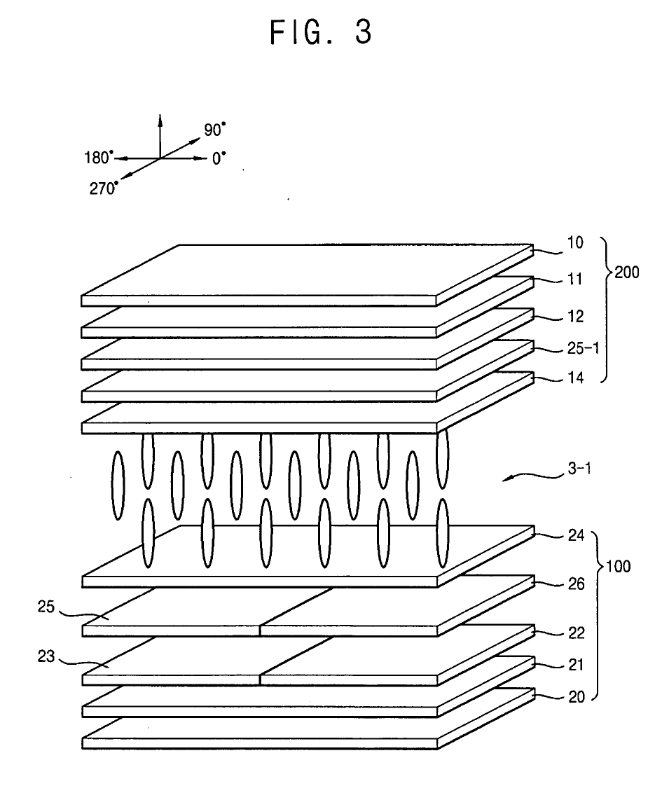

FIG. 3 is a view showing a transflective display apparatus according to another exemplary embodiment of the present invention. In FIG. 3, the reference numerals denote the same elements as in FIG. 1, and thus any repetitive descriptions of the same elements will be omitted.

Referring to FIG. 3, the transflective display apparatus includes the first panel 100, the second panel 200 and a liquid crystal layer 3-1 disposed between the first panel 100 and the second panel 200.

The first panel 100 has the first substrate 21 and the pixel electrode on the first substrate 21. The pixel electrode has the transparent electrode 23 and the reflective electrode 22. A lower retardation layer 25 is disposed on the transparent electrode 23, and the complementary layer 26 is disposed on the reflective electrode 22. The first liquid crystal alignment layer 24 is disposed on the lower retardation layer 25 and the complementary layer 26. The lower polarizing plate 20 is attached to the lower surface of the first substrate 21.

The second panel 200 has the second substrate 11, the common electrode 12 formed on the second substrate 11, an upper retardation layer 25-1 interposed between the common electrode 12 and the second liquid crystal alignment layer 14. The upper polarizing plate 10 is attached to the upper surface of the second substrate 11.

The liquid crystal layer 3-1 includes a liquid crystal material having a negative permittivity anisotropy such as a vertical alignment (VA) mode liquid crystal material.

The transmitting axis of the lower polarizing plate 20 is substantially parallel to a transmitting axis of the upper polarizing plate 10. As a result, when the transmitting axis of the lower polarizing plate 20 is along the 0 (or 180)-degree direction, the transmitting axis of the upper polarizing plate 10 is also along the 0 (or 180)-degree direction.

The first and second liquid crystal alignment layers 24 and 14 align liquid crystal molecules of the liquid crystal layer 3-1 perpendicularly to the alignment layers 24,14, so that the liquid crystal layer 3-1 is in vertical alignment mode.

The lower and upper retardation layers 25 and 25-1 and the complementary layer 26 are similar to the retardation layer and the complementary layer as described with reference to FIG. 1. In the present embodiment, a phase changing axis of the upper retardation layer 25-1 may be substantially parallel to a phase changing axis of the lower retardation layer 25, and the phase changing axes of the lower retardation layer 25 and the upper retardation layer 25-1 may be substantially perpendicular to the phase changing axis of the liquid crystal layer 3-1.

An inductive layer (not shown) may be formed between the transparent electrode 23 and the lower retardation layer 25, between the reflective electrode 22 and the complementary layer 26, and between the common electrode 12 and the upper retardation layer 25-1. The inductive layer aligns the phase changing axes of the lower and upper retardation layers 25 and 25-1 and the complementary layer 26 according to surface characteristics of these layers 25, 25-1, 26.

A surface of the first liquid crystal alignment layer 24 is processed along a +45-degree direction and a surface of the second liquid crystal alignment layer 14 is processed along a −45-degree direction opposite to the +45-degree direction of the first liquid crystal alignment layer 24.

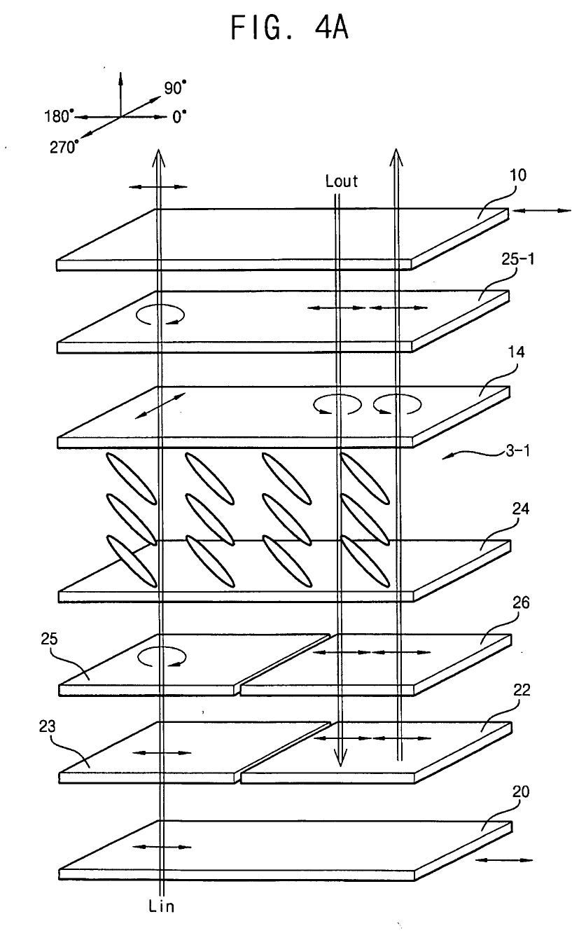

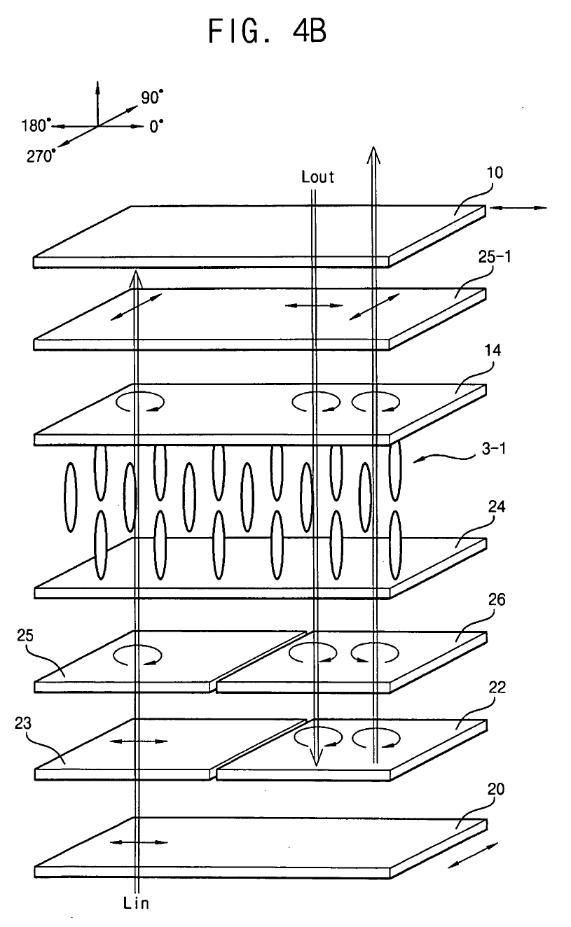

FIG. 4A is a view showing a polarized light when a white image is displayed on a screen of the transflective display apparatus of FIG. 3. FIG. 4B is a view showing a polarized light when a black image is displayed on the screen of the transflective display apparatus of FIG. 3.

In FIGS. 4A and 4B, transmitting axes of the upper and lower polarizing plates 10 and 20 are parallel to the 0 (or 180)-degree direction. When a voltage is applied to the liquid crystal layer 3-1 as shown in FIG. 4A, the liquid crystal layer 3-1 functions as a ¼ wavelength retardation layer having a phase changing axis parallel with the −45-degree direction. When the voltage is not applied to the liquid crystal layer 3-1 as shown in FIG. 4B, the liquid crystal layer 3-1 does not change a phase of a light passing through the liquid crystal layer 3-1.

Referring to FIG. 4A, in the transmissive area, the internal light Lin from the backlight (not shown) disposed under the first substrate sequentially passes through the lower polarizing plate 20, the transparent electrode 23, the lower retardation layer 25, the first liquid crystal alignment layer 24, the liquid crystal layer 3-1, the second liquid crystal alignment layer 14, the upper retardation layer 25-1 and the upper polarizing plate 10. In detail, the internal light Lin is linearly polarized along the 0 (or 180)-degree direction by the lower polarizing plate 20, and then the linearly polarized light is converted into a first circularly polarized light or a first elliptically polarized light by the lower retardation layer 25. A phase of the first circularly polarized light or the first elliptically polarized light is changed by the liquid crystal layer 3-1 to which an operational voltage is applied, and is further polarized by the upper retardation layer 25-1 so that the first circularly polarized light or the first elliptically polarized light is converted into a second circularly polarized light or a second elliptically polarized light. Therefore, the second circularly polarized light or the second elliptically polarized light has a component vibrating along the 0 (or 180)-degree direction and passes through the transmitting axis of the upper polarizing plate 10.

In the reflective area, the external light Lout sequentially passes through the upper polarizing plate 10, the upper retardation layer 25-1, the second liquid crystal alignment layer 14, the liquid crystal layer 3-1, the first liquid crystal alignment layer 24 and the complementary layer 26. Then, the external light Lout is reflected from the reflective electrode 22 and sequentially passes through the complementary layer 26, the first liquid crystal alignment layer 24, the liquid crystal layer 3-1, the second liquid crystal alignment layer 14, the upper retardation layer 25-1 and the upper polarizing plate 10. In detail, the external light Lout is polarized along the 0 (or 180)-degree direction by the upper polarizing plate 10, and then is converted into a first circularly polarized light or a first elliptically polarized light by the upper retardation layer 25-1. Thereafter, a phase of the first circularly polarized light or the first elliptically polarized light is changed by the liquid crystal layer 3-1, so that the first circularly polarized light or the first elliptically polarized light is linearly polarized along the 0 (or 180)-degree direction. The linearly polarized light is reflected by the reflective electrode 22, and then linearly polarized along the 0 (or 180)-degree direction by the liquid crystal layer 3-1 and the upper retardation layer 25-1. Therefore, the linearly polarized light has a component vibrating along the 0 (or 180)-degree direction, and thus passes through the transmitting axis of the upper polarizing plate 10.

In the transmissive area, the internal light Lin is polarized along the 0 (or 180)-degree direction by the lower polarizing plate 20. The linearly polarized light sequentially passes through the lower retardation layer 25, the liquid crystal layer 3-1 and the upper retardation layer 25-1, so that the linearly polarized light is converted to the first circularly polarized light. Both of the lower and upper retardation layers 25 and 25-1 and the liquid crystal layer 3-1 have a phase changing axis parallel to the 45-degree direction, respectively, so that the phase of the linearly polarized light is changed by a ¼ wavelength, respectively. The first circularly polarized light has a component vibrating in the 0 (or 180)-degree direction, and thus passes through the transmitting axis of the upper polarizing plate 10.

In the reflective area, the external light Lout is converted into a linearly polarized light polarized along the 0 (or 180)-degree direction by the upper polarizing plate 10. The linearly polarized light along the 0 (or 180)-degree direction sequentially passes through the upper retardation layer 25-1 and the liquid crystal layer 3-1. The upper retardation layer 25-1 has a phase changing axis parallel to the 45-degree direction, so a phase of the linearly polarized light along the 0 (or 180)-degree direction is changed to about ¼ wavelength. The liquid crystal layer 3-1 has a phase changing axis that is parallel to the −45-degree direction, so that the phase of the linearly polarized light along the 0 (or 180)-degree direction is changed to an amount of about ¼ wavelength. The linearly polarized light along the 0 (or 180)-degree direction has a component vibrating along the 0 (or 180)-degree direction, and thus passes through the transmitting axis of the upper polarizing plate 10.

Referring to FIG. 4B, in the transmissive area, the internal light Lin is linearly polarized along the 0 (or 180)-degree direction by the lower polarizing plate 20, and is converted into a first circularly polarized light or a first elliptically polarized light by the lower retardation layer 25. The first circularly polarized light or the first elliptically polarized light passes through the liquid crystal layer 3-1 without further polarization. Next, the first circularly polarized light or the first elliptically polarized light is again polarized along the 90 (or 270)-degree direction by the upper retardation layer 25-1, and is converted to a linearly polarized light along the 90 (or 270)-degree direction. The linearly polarized light along the 90 (or 270)-degree direction does not include a component vibrating along the 0 (or 180)-degree direction, and thus does not pass through the transmitting axis of the upper polarizing plate 10.

In the reflective area, the external light Lout is polarized along the 0 (or 180)-degree direction, and is converted to a first circularly polarized light or a first elliptically polarized light after passing through the upper retardation layer 25-1. The first circularly polarized light or the first elliptically polarized light passes through the liquid crystal layer 3-1 and the complementary layer 26 without further polarization. Next, the first circularly polarized light or the first elliptically polarized light is reflected from the reflective electrode 22, and then passes through the complementary layer 26 to convert the first circularly polarized light or the first elliptically polarized light to a second circularly polarized light or a second elliptically polarized light. The second circularly polarized light or a second elliptically polarized light rotates in a direction opposite to the first circularly polarized light or a first elliptically polarized light. The second circularly polarized light or a second elliptically polarized light passes through the liquid crystal layer 3-1 without any further polarization, and is linearly polarized along the 90 (or 270)-degree direction by the upper retardation layer 25-1. The linearly polarized light along the 90 (or 270)-degree direction does not include a component vibrating along the 0 (or 180)-degree direction, and thus does not pass through the transmitting axis of the upper polarizing plate 10.

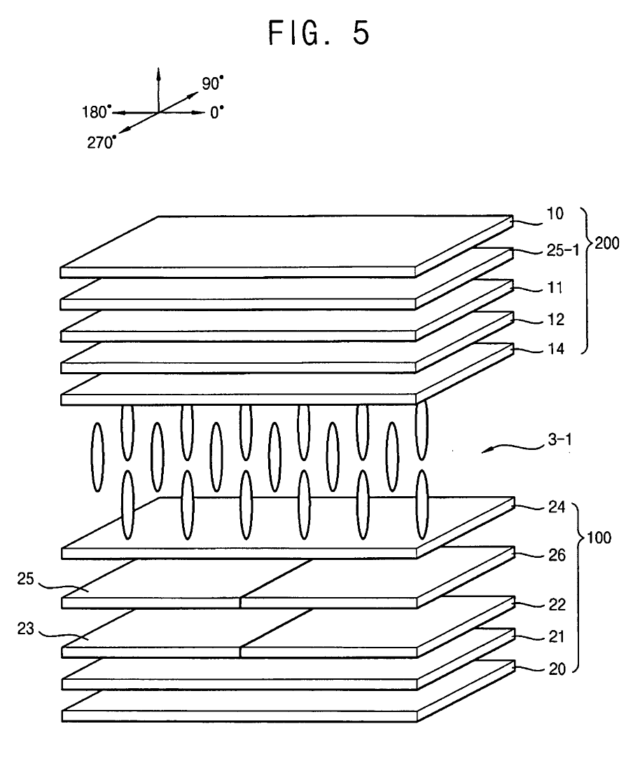

FIG. 5 is a view showing a transflective display apparatus according to still another exemplary embodiment of the present invention. The transflective display apparatus in the present embodiment has a structure substantially identical to that of the transflective display apparatus shown in FIG. 3, except that the upper retardation layer 25-1 is interposed between the second substrate 11 and the upper polarizing plate 10, rather than between the common electrode 12 and the second liquid crystal alignment layer 14. In FIG. 5, the eference numerals denote the same elements as in FIG. 3, and thus any repetitive descriptions of the same elements will be omitted.

Referring to FIG. 5, a transflective display apparatus has the upper retardation layer 25-1 between the second substrate 11 and the upper polarizing plate 10.

The second panel 200 has the second substrate 11, the upper retardation layer 25-1 attached to the upper surface of the second substrate 11, and the common electrode 12 formed between the second substrate 11 and the second liquid crystal alignment layer 14. The upper polarizing plate 10 is formed on the upper retardation layer 25-1.

Operations of the transflective display apparatus shown in FIG. 5 are the same as those described with reference to FIGS. 4A and 4B, and further detailed descriptions on the operations are omitted.

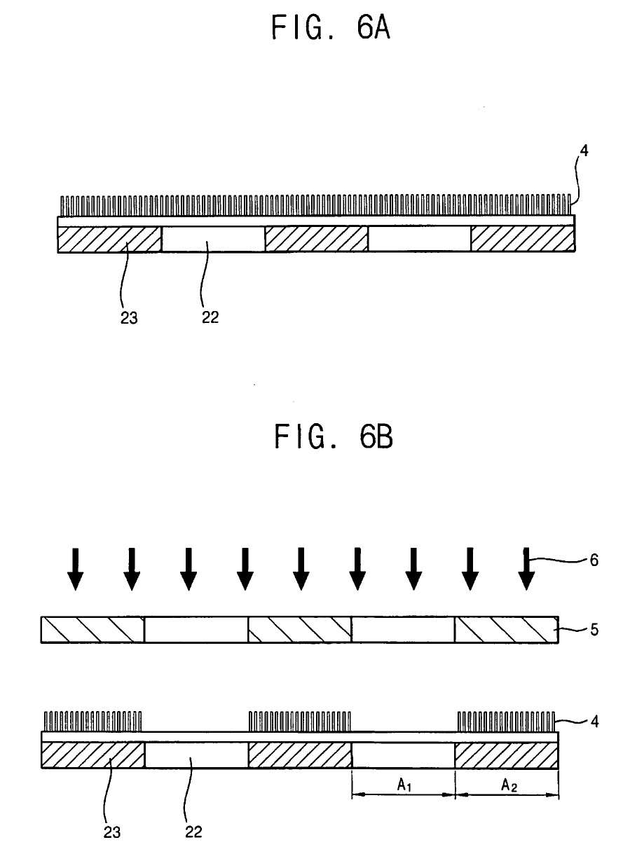

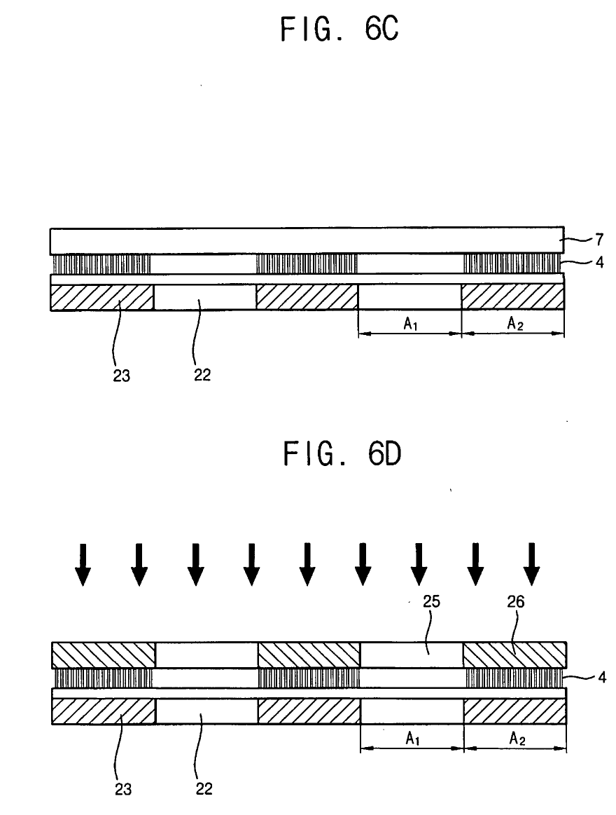

FIGS. 6A to 6D are views showing processing steps for a method of forming the retardation layer and complementary layer of the transflective display apparatus according to an exemplary embodiment of the present invention. Referring to FIG. 6A, an inductive layer 4 is formed on the transparent electrode 23 and the reflective electrode 22 through a spin coating process or a roll printing process. In the present embodiment, the inductive layer 4 includes JALS203 manufactured by JSR Corporation in Japan.

As shown in FIG. 6B, a mask 5 is disposed on the inductive layer 4, and an electromagnetic wave 6 such as an ultraviolet ray is partially irradiated onto a surface of the inductive layer 4 using the mask 5 as an irradiation mask, so that the inductive layer is divided into an exposed region Al and a non-exposed region A2. The electromagnetic wave 6 changes the surface characteristics of the inductive layer 4, so that the surface characteristics of the exposed region A1 are different from those of the non-exposed region A2. When the ultraviolet ray is irradiated onto the surface of the inductive layer 4, molecules of the surface of the inductive layer 4 are decomposed and chemically recombined, thereby causing a change in the surface characteristics. For example, a hydrophobic surface of the inductive layer 4 is changed to a hydrophilic surface at the exposed region A1, so that the surface characteristics of the exposed region A1 is different from the non-exposed region A2 of the inductive layer 4.

Referring to FIG. 6C, an optical anisotropic layer 7 including an optical anisotropic material (such as a light-curable liquid crystal material) is formed on the inductive layer 4 including the exposed region A1 and the non-exposed region A2. In the present embodiment, the optical anisotropic layer 7 is formed through a roll printing process, and the optical anisotropic material includes LC242 manufactured by BASF Company in Germany. An annealing process is performed on the optical anisotropic layer 7 so that a phase changing axis of the optical anisotropic material is aligned in accordance with the surface characteristics of the inductive layer 4.

Referring to FIG. 6D, the ultraviolet ray is again irradiated onto the optical anisotropic layer 7 and a curing and a hardening process are performed on the optical anisotropic layer 7, thereby forming the retardation layer 25 in the exposed region A1 of the inductive layer and forming the complementary layer 26 in the non-exposed region A2 on the inductive layer 4 corresponding to the non-exposing region A2. The retardation layers 25 and 25-1 disclosed in FIGS. 1, 3 and 5 are formed in the same process as described above.

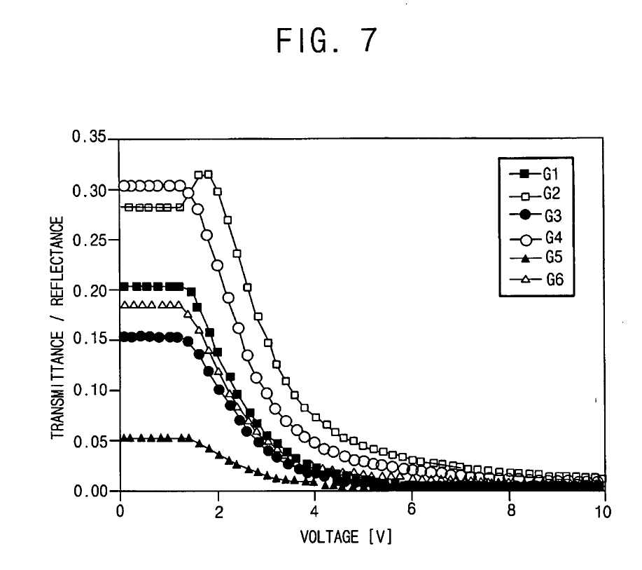

FIG. 7 is a graph showing the transmittance and the reflectance of light as a function of an operational voltage of the transflective display apparatus of FIG. 1 in accordance with a twisting angle of a liquid crystal. In FIG. 7, the X-axis represents the operational voltage (V) and the Y-axis represents the transmittance (%) or reflectance (%). The transmittance was determined as a ratio of the intensity of light outputted from the liquid crystal layer to the intensity of light supplied to the liquid crystal layer in the transmissive area. The reflectance was determined as a ratio of the intensity of light outputted from the liquid crystal layer to the intensity of light supplied to the liquid crystal layer in the reflective area.

In FIG. 7, the first graph G1 and the second graph G2 represent the transmittance and the reflectance, respectively, of a transflective display apparatus in which the liquid crystal layer has a twisting angle of about forty-five degrees. The third graph G3 and the fourth graph G4 represent the transmittance and the reflectance, respectively, of a transflective display apparatus in which the liquid crystal layer has a twisting angle of about sixty degrees. The fifth graph G5 and the sixth graph G6 represent the transmittance and the reflectance, respectively, of a transflective display apparatus in which the liquid crystal layer has a twisting angle of about seventy-five degrees.

Referring to FIG. 7, the first and second graphs G1 and G2 indicate that the reflectance increased to more than about 0.31%, and the transmittance decreased to less than about 0.15% at a voltage of about two volts. On the other hand, as shown in the third to sixth graphs G3 to G6, the reflectance and transmittance gradually decrease in a voltage range of approximately two volts to approximately ten volts.

As shown in FIG. 7, when the twisting angle of the liquid crystal is about forty-five degrees, the reflectance changes rapidly, reaching a maximum at a voltage of about two volts, but the transmittance does not show as dramatic of a change. That is, the change in reflectance follows a different pattern from the change in transmittance when the twisting angle of the liquid crystal is about forty-five degrees. However, when the twisting angle of the liquid crystal is about 65 degrees and about seventy-five degrees, the reflectance and the transmittance react more similarly to the change in voltage than when the liquid crystal angle is about 45 degrees.

The reflectance and the transmittance of the transflective liquid crystal apparatus vary according to voltage in a manner that is substantially identical to each other in view of display characteristics such as display quality. Preferably, the reflectance and the transmittance are as high as possible in view of the light efficiency of the display apparatus. For these reasons, the twisting angle of the liquid crystal layer is preferably selected to be about sixty degrees in view of the display characteristics and the light efficiency. However, small deviations from the sixty-degree angle may be acceptable in view of other constraints such as power consumption and market trend, as would be known to one of the ordinary skill in the art.

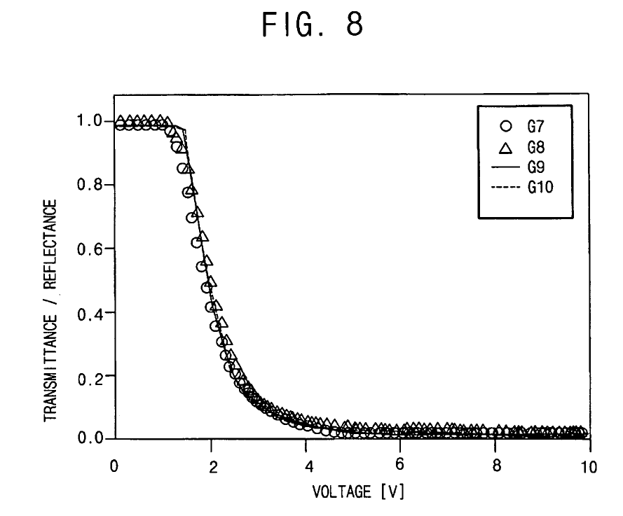

FIG. 8 is a graph showing a theoretical and measured transmittance and reflectance of the transflective display apparatus as a function of an operational voltage when the twisting angle is about sixty degrees. In FIG. 8, the seventh graph G7 represents the measured transmittance, and the eighth graph G8 represents the measured reflectance. The ninth graph G9 represents a theoretical transmittance and the tenth graph G10 represents a theoretical reflectance. In addition, all of the transmittance and reflectance values are normalized to have a maximum value of one so as to facilitate an inspection on the variation of the reflectance and the transmittance. The measured reflectance and transmittance were obtained from a specimen apparatus in which the liquid crystal layer had a thickness of about 1.8 μm and in which the liquid crystal alignment layer included JALS1051 manufactured by JSR Corporation in Japan. In the specimen apparatus, the nematic crystal layer included MLC6012 manufactured by Merck KGaA in Germany, the retardation layer included LC242 manufactured by BASF Company in Germany, and the inductive layer included JALS203 manufactured by JSR Corporation in Japan. The LC242 is a light-cured liquid crystal dissolved into liquid chloroform at a percentage concentration of about twenty percent.

Referring to FIG. 8, the seventh to tenth graphs G7 to G10 indicate that the reflectance and transmittance gradually decrease in the voltage range between approximately two volts and approximately ten volts. According to the graphs, the reflectance and the transmittance react to the change in voltage in a substantially same manner. The results in FIG. 8 suggest that the reflective area and the transmissive area of the transflective display apparatus may be operated by the same driving method in spite of the operational distinctions as described above.

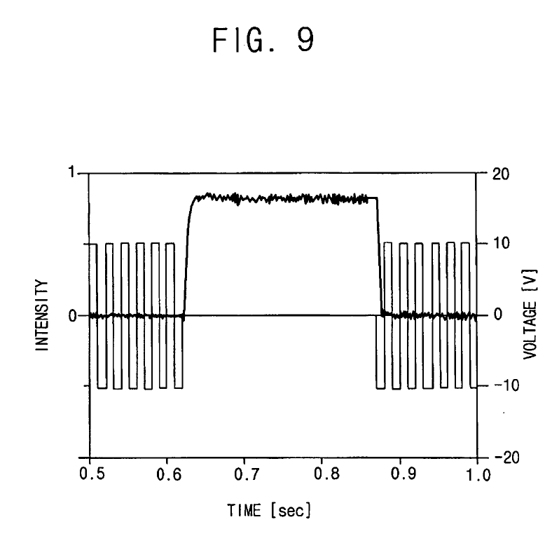

FIG. 9 is a graph showing a response characteristic of the transflective display apparatus in which a twisting angle is about sixty degrees. The response characteristic was measured on the same specimen apparatus that was used for measuring the transmittance and reflectance in FIG. 8. In FIG. 9, the horizontal axis represents a time at which an operational voltage is applied to the transflective display apparatus, and the two vertical axes represent the operational voltage and a normalized intensity, respectively. As shown in FIG. 9, the response characteristic of the specimen apparatus is superior to a conventional transflective display apparatus because the thickness of the liquid crystal layer in the specimen apparatus is measured about 1.8 μm smaller than a conventional thickness of about 5 μm in the conventional apparatus. FIG. 9 indicates that an on-response time, a response time when the operational voltage is applied to the apparatus, is about 5.8 ms, and an off-response time, a response time when the operational voltage is cut off, is about 0.8 ms. The above measured on-response time and off-response time is sufficient for displaying moving pictures in the transflective display apparatus of the present invention.

According to the transflective display apparatus of the present invention, a cell-gap in the reflective area is substantially the same as in the transmissive area. The advantage here is that the reflective area and the transmissive area of the transflective display apparatus are operated by the same driving method in spite of the operational distinctions, thereby simplifying a manufacturing process and improving a product reliability. In addition, a complementary layer that includes an optical anisotropic material is formed inside or outside of a liquid crystal panel, thereby reducing the thickness of the transflective display apparatus.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is calimed is:

1. A display apparatus comprising:
a first substrate;
a pixel electrode having a reflective electrode reflecting a external light and a transparent electrode transmitting an internal light, the pixel electrode being formed on the first substrate; and
a retardation layer on at least one of the reflective electrode and the transparent electrode.

2. The display apparatus of claim 1, wherein the retardation layer converts a linearly polarized light supplied to the retardation layer into a circularly polarized light or an elliptically polarized light.

3. The display apparatus of claim 2, wherein a first axis component of a linearly polarized light supplied to the retardation layer has a first wavelength, and a second axis component of the linearly polarized light has a second wavelength, and the retardation layer changes a phase of the first axis component so that the first wavelength is in a wavelength range from about one-tenth of the second wavelength to about half of the second wavelength.

4. The display apparatus of claim 3, wherein the retardation layer changes the phase of the first axis component so that the first wavelength is about a quarter of the second wavelength.

5. The display apparatus of claim 1, wherein the retardation layer comprises a first retardation layer on the reflective electrode and a second retardation layer on the transparent electrode.

6. The display apparatus of claim 1, wherein the retardation layer is formed on one of the reflective electrode and the transparent electrode, and an insulation layer is formed on a remaining one of the reflective electrode and the transparent electrode to a same thickness as the retardation layer, so that the insulation layer has a height substantially identical to that of the retardation layer.

7. The display apparatus of claim 1, further comprising an inductive layer between the retardation layer and the pixel electrode.

8. A display apparatus comprising:
a first panel including a first substrate on which a pixel electrode is formed, the pixel electrode having a transparent electrode for transmitting an internal light and a reflective electrode for reflecting an external light;
a second panel including a second substrate facing the first substrate, the second substrate on which a common electrode is formed being spaced apart from the first substrate;
a variable retardation layer between the pixel electrode and the common electrode; and
a lower retardation layer on one of the transparent electrode and the reflective electrode.

9. The display apparatus of claim 8, wherein the variable retardation layer includes a liquid crystal layer having twisted nematic liquid crystal, and the variable retardation layer rotates a linearly polarized light to an amount of a predetermined angle in a range from about forty-five degrees to about ninety degrees.

10. The display apparatus of claim 9, wherein the lower retardation layer is disposed on the reflective electrode.

11. The display apparatus of claim 8, wherein the variable retardation layer comprises liquid crystal in a vertical alignment mode, a first axis component of a light supplied to the variable retardation layer being converted into about 1/4 wavelength from a second axis component in the vertical alignment mode.

12. The display apparatus of claim 11, wherein the lower retardation layer is disposed on the transparent electrode, and the second panel further comprises an upper retardation layer.

13. The display apparatus of claim 12, further comprising an inductive layer interposed between the second panel and the upper retardation layer.

14. The display apparatus of claim 12, wherein the upper retardation layer is disposed on the common electrode.

15. The display apparatus of claim 12, wherein the upper retardation layer is disposed on a first surface of the second substrate opposite to a second surface on which the common electrode is formed.

16. The display apparatus of claim 12, wherein the upper retardation layer converts a linearly polarized light supplied to the upper retardation layer into a circularly polarized light or an elliptically polarized light.

17. The display apparatus of claim 16, wherein a first axis component of a linearly polarized light supplied to the upper retardation layer has a first wavelength, and a second axis component of the linearly polarized light has a second wavelength, and the upper retardation layer changes a phase of the first axis component so that the first wavelength is in a wavelength range from about one-tenth of the second wavelength to about half of the second wavelength.

18. The display apparatus of claim 17, wherein the lower retardation layer has a first phase changing axis and the upper retardation layer has a second phase changing axis substantially parallel with the first phase changing axis.

19. The display apparatus of claim 18, wherein the variable retardation layer has a third phase changing axis substantially perpendicular to the first and second phase changing axes.

20. A method of manufacturing a display apparatus comprising:
forming a pixel electrode on a first substrate, the pixel electrode including a transparent electrode transmitting an internal light and a reflective electrode reflecting an external light; and
forming a retardation layer on at least one of the reflective electrode and transparent electrode.

21. The method of claim 20, wherein the forming the retardation layer comprises:
forming a first inductive layer and a second inductive layer on the reflective electrode and the transparent electrode, respectively;
changing surface characteristics of the first and the second inductive layers;
forming an optical anisotropic layer including an optical anisotropic material on the first and the second inductive layers; and
curing the optical anisotropic layer so as to align the optical anisotropic material in accordance with a surface characteristic of the first or second inductive layer.

22. The method of claim 21, wherein changing the surface characteristics of the first and the second inductive layers includes:
placing a mask on the first and the second inductive layers; and
irradiating an electromagnetic wave having a wavelength no more than about 400 nm onto a surface of at least one of the first or second inductive layers.

23. The method of claim 21, wherein changing the surface characters of the first and the second inductive layers includes:
placing a mask on the first and the second inductive layers; and
colliding an accelerated particle or ion against a surface of at least one of the first or the second inductive layers.
